(19) United States
(12) Patent Application Publication
(10) Pub. No.: US 2019/0040221 A1
(43) Pub. Date: Feb. 7, 2019

(54) METHOD FOR PRODUCING A SOUND- AND/OR HEAT-INSULATING ELEMENT, AND SOUND- AND/OR HEAT-INSULATING ELEMENT

(71) Applicant: STO SE & CO. KGAA, Stühlingen (DE)

(72) Inventors: Martin Hitzler, Gottmadingen (DE); Andreas Weier, Trossingen (DE); Gerald Burgeth, Lauchringen (DE)

(21) Appl. No.: 16/074,029

(22) PCT Filed: Nov. 17, 2016
(86) PCT No.: PCT/EP2016/077962

§ 371 Date: Jul. 30, 2018

(30) Foreign Application Priority Data
Feb. 19, 2016 (EP) 16156509.8

(51) Int. Cl. C08J 9/232; C08J 9/236; C08K 3/04

(52) U.S. Cl. CPC C08J 9/232; C08J 9/236; C08K 3/04; C08J 2201/038; C08J 2301/12; E04B 1/88; C08J 2323/12; C08J 2325/06; C08J 2367/06; C08J 2375/04; C08J 2323/06

(57) ABSTRACT

The invention relates to a method for producing a sound and/or thermal insulation element using foamable and/or prefoamed polymer particles which are coated with a binding agent, and preferably with an organic binding agent, and thereafter are subjected to a shaping process during which the polymer particles are bonded and/or sintered to one another, the bonding being caused by way of the binding agent. According to the invention, a non-hydrophilic binding agent is used for coating the foamable and/or prefoamed polymer particles.

The invention furthermore relates to a sound and/or thermal insulation element.

The invention relates to a method for producing a sound and/or thermal insulation element having the features of the preamble of claim 1. The invention furthermore relates to a sound and/or thermal insulation element having the features of the preamble of claim 12.

### PRIOR ART

Insulating elements for the sound and/or thermal insulation of buildings can be produced from a wide variety of insulation materials. Insulating elements made of polystyrene particle foam, however, are used particularly frequently, in particular in the façade region. These not only have high insulating values, but moreover are comparatively cost-effective to produce. The high insulating values can primarily be attributed to the air-filled pores or cells that are formed during foaming of the polystyrene particles. Analogously, other polymers are also suitable for creating insulation materials, provided the particles thereof are foamable. The larger the total air-filled pore volume or cell volume is, the better are, in general, the insulation properties, and in particular the thermal insulation properties, of the particular insulation material.

The overall pore volume or overall cell volume also includes an interstitial volume remaining between the particles which, depending on the degree of fusion and/or compaction of the starting materials, may vary in size.

A shaped body for the sound and/or heat insulation of buildings and a method for producing such a shaped body are known from EP 2 527 124 A1, for example. In the method, prefoamed polystyrene particles are fused and/or compacted under the action of pressure and/or heat, so that a contiguous cavity volume, consisting of the interstitial spaces between the particles, is preserved in the shaped body. Due to the contiguous cavity volume, the shaped body is able to absorb and subsequently give off water vapor and water. The shaped body proposed for the sound and/or thermal insulation of buildings can thus be used in particular as a drainage board. However, active water absorption and temporary storage, for example due to the formation of capillaries, is to be prevented since this lowers the thermal insulation performance of the shaped body.

It is furthermore proposed in EP 2 527 124 A1 to coat the polystyrene particles with a binding agent prior to fusion and/or compaction. The bond of the polystyrene particles among one another is then primarily caused by the binding agent applied to the particles from the outside, wherein this is preferably an organic binding agent. The bond caused by binding agent is intended to increase, in particular, the mechanical stability of the formed body.

However, it has been found that a shaped body made of polystyrene particle foam in which the polystyrene particles were coated with an organic binding agent prior to fusion and/or compaction tends toward higher water absorption than shaped bodies made of uncoated polystyrene particles. This can be attributed to the fact that the polystyrene particles, which are hydrophobic per se, are covered by a binding agent layer that acts less hydrophobically, or even hydrophilically, with respect to the polystyrene particles. Since the binding agent coating also forms a three-dimensional network-like structure that extends through the entire shaped body, penetrating moisture is retained inside the shaped body by the binding agent. As a result, the thermal insulation performance decreases.

Furthermore, polymer particles that, in contrast to polystyrene particles, do not exhibit hydrophilic properties are known. These include, in particular, particles made of biopolymers. Biopolymers can be composed of natural polymers, such as polylactic acid or cellulose derivatives. Furthermore, they can be made of synthetically produced monomers, in the production of which, in turn, natural raw materials are used. Polyethylene can be cited as an example, provided the ethylene that is used is produced from natural organic waste material. Biopolymers can thus also be polymers of biogenic origin. When the polymers are naturally biodegradable they can also be referred to as biopolymers.

To the extent that biopolymers are used in the present case, these shall be understood to mean, in particular, polar, hydrophilic polymers composed of polar, hydrophilic monomers.

Polymer particle foams made of biopolymers tend toward increased water absorption, whereby they are less suited for forming a sound and/or thermal insulation element. This holds true unless additional measures are taken that protect the sound and/or thermal insulation element from increased water absorption.

For example, an insulation and drainage board made of foamed polymer particles is known from EP 2 366 847 A1, which have been bonded by way of a binding agent. In this way, interstitial spaces remain between the particles, which form a contiguous network-like cavity volume via which the water may be drained by way of gravity. So as to support drainage of the moisture inside the board, the board proposed in this published prior art comprises a tapered free end which ends up at the bottom when the board is attached to the outside of a building wall, and focuses the moisture in a funnel-like manner toward the center of the board. Furthermore, subsequent impregnation of the board with an impregnating agent is proposed, which is intended to decrease the hydrophilicity and further improve the drainage properties.

Proceeding from the above-described related art, it is the object of the present invention to provide a sound and/or thermal insulation element made of a polymer particle foam which offers good insulating values and additionally has a low water absorption ability. Furthermore, the sound and/or thermal insulation element is to be easy and cost-effective to produce.

To achieve the object, the method having the features of claim 1 and the sound and/or thermal insulation element having the features of claim 12 are provided.

### SUMMARY OF THE INVENTION

The provided method for producing a sound and/or thermal insulation element uses foamable and/or prefoamed polymer particles. The foamable and/or prefoamed polymer particles are coated with a binding agent and thereafter subjected to a shaping process during which the polymer particles are bonded and/or sintered to one another. The bonding is caused by way of the binding agent. According to the invention, a non-hydrophilic binding agent is used for coating the foamable and/or prefoamed polymer particles.

The non-hydrophilic binding agent results in the formation of a coating enveloping the polymer particles, which serves not only the bonding of the polymer particles, but additionally lowers the hydrophilicity of the sound and/or thermal insulation produced by the method. This means that a sound and/or thermal insulation element produced by the method according to the invention exhibits a lower water absorption ability.

The use of a non-hydrophilic binding agent thus makes subsequent impregnation of the sound and/or thermal insulation element for the purpose of lowering the hydrophilicity dispensable. This means that the production of a sound and/or thermal insulation element having a reduced water absorption ability is simplified by the method according to the invention. This furthermore has a cost-reducing effect since not only is an additional work step eliminated, but the non-hydrophilic binding agent also replaces the impregnating agent.

Due to the reduced hydrophilicity of the sound and/or thermal insulation element produced by the method according to the invention, less moisture is actively absorbed. The reason for this is that the lower the hydrophilicity, the worse is the wetting behavior. This means that water drops tend less toward spreading and ideally roll off in a bead-shaped manner. As a result, considerably less water is deposited or absorbed on the polymer particles or the coating thereof. In this way, the coating comprising the non-hydrophilic binding agent counteracts active water absorption.

A sound and/or thermal insulation element produced by the method according to the invention is thus suitable, in particular, for use in outdoor areas and/or in areas particularly prone to moisture. Moreover, the element is suitable for use as a drainage element or board.

The non-hydrophilic binding agent is preferably an organic polymer binding agent. Such a binding agent has high binding strength, whereby a stable bond of the polymer particles among one another is achieved.

The hydrophilicity of an organic polymer binding agent is decisively determined by the following factors:
the polarity of the monomers,
the arrangement of the monomers among one another, and
the length and degree of cross-linking of the polymer chains.

To the extent that additives are added to the binding agent for forming the coating, for example so as to improve the processability of the binding agent, the type and quantity of the additives furthermore play a role.

Since manufacturers of binding agents generally do not provide any information with regard to the above-mentioned factors, the hydrophilicity of the binding agent has to be determined by way of experimentation and/or based on other factors and/or parameters.

For example, the contact angle (CA) of water and of diiodomethane on the binding agent surface can be determined by way of experimentation. The surface energy (SE) is then calculated from the contact angles, which is composed of a polar part (PP) and a (nonpolar) dispersive part (DP). The polar part (PP) is a measure of the interaction between the surface and a polar substance, such as water. The dispersive part (DP) is a measure of the interaction between the surface and a nonpolar substance, such as oil.

In this, it is not only the absolute variables of the SE, the PP and of the DP that allow the hydrophilic properties of a surface to be derived, but also the ratios of the variables to one another: DP/PP, PP/SE and DP/SE.

All of the above-described parameters can be ascertained by way of experimentation, so that experiments in this regard preferably precede the execution of the method according to the invention. In this way, it can be established in advance as to whether a binding agent is “non-hydrophilic” and thus suitable for carrying out the method according to the invention.

For the ascertainment or determination of the relevant parameters by way of experimentation, furthermore preferably the pure binding agent is applied to a Lenetta film using a doctor blade in a wet layer thickness of 250 μm. After drying for three days at 23° C. and 50% relative humidity, the contact angle of a water drop is measured after an equilibration time of one minute on the surface of the binding agent layer using a Krüss Mobile Drop GH11 (Advance Software Version 1.2.1). The contact angle of diiodomethane is determined in the same manner on the surface of the binding agent layer. Thereafter, the surface energy is ascertained in accordance with DIN 55660-2 (December 2011), and according to the Owens, Wendt, Rabel and Kaeble (OWRK) method, and the polar part and the dispersive part are ascertained. If the binding agent is a dispersion powder, this is redispersed in advance with water, so that the polymer solids content is 50 wt. %.

Preferably, a binding agent that, after 1 minute of equilibration, has an initial static contact angle of water of ≥35°, preferably ≥40°, and more preferably ≥50°, is used in the method according to the invention.

The suitability of a binding agent for carrying out the method according to the invention can, alternatively or additionally, be established based on the surface energy of the binding agent. Preferably a binding agent is used which has a surface energy of ≤70 mN/m, preferably ≤65° mN/m, and more preferably ≤60 mN/m. However, the surface energy should exceed 30 mN/m.

Moreover, preferably a binding agent is used which has a polar part of the surface energy of ≤35 mN/m, preferably ≤30 mN/m, and more preferably ≤25 mN/m. Preferably, a drop below 1 mN/m should not occur.

Furthermore, preferably a binding agent is used which has a nonpolar part of the surface energy of ≥10 mN/m, preferably ≥20 mN/m, and more preferably ≥30 mN/m. However, the dispersive part of the surface energy should not exceed 60 mN/m.

The ratio of the variables that are the surface energy (SE), the polar part (PP) and the dispersive part (DP) with respect to one another is particularly important.

The DP/PP ratio is especially >1.0, preferably >1.4, and more preferably >1.6. The measurement of the contact angle with water already allows the PP/DP ratio to be inferred. A small contact angle (water) means that the polar portion is high, resulting in a PP/DP ratio that is comparatively small.

The PP/SE ratio is especially <0.50, preferably <0.45, and more preferably <0.40.

This results in values of 0.50, preferably >0.55 and more preferably >0.60 for the DP/SE ratio.

A “non-hydrophilic” binding agent within the meaning of the present application shall thus preferably be understood to mean an organic polymer binding agent, on the surface of which contact angles≥35° with water are formed, where the surface has a SE≤70 mN/m, the polar portion of the SE is ≤35 mN/m, and the dispersive part of the SE is ≥30 mN/m.

According to a preferred embodiment of the invention, an aqueous polymer dispersion based on acrylate, (meth)acrylate, styrene acrylate, vinyl acetate, vinyl acetate ethylene, vinyl esters, vinyl chloride, polyurethane, polysiloxane and/or silicone resins is used as the binding agent. This has the advantage of surrounding the polymer particles in a film-like manner during coating, so that an approximately uniform distribution of the binding agent is ensured. Moreover, the adhesion of the binding agent to the polymer particles can be improved through the use of an aqueous polymer dispersion. As an alternative, it is also possible to use a dry dispersion powder based on acrylate, styrene acrylate, vinyl acetate, vinyl acetate ethylene and/or vinyl chloride as the binding agent. The adhesion of the dry dispersion powder on the polymer particles can be improved by moistening the particles beforehand and/or by using prefoamed polymer particles that still have residual moisture.

It is furthermore provided that foamable and/or prefoamed polymer particles made of polystyrene, polyurethane, polypropylene, polyethylene and/or polyethylene terephthalate are used. These polymers comprise monomers that are nonpolar and therefore absorb very little water or are water repellent. This applies accordingly for the polymer particle foams produced therefrom. Due to the coating with a non-hydrophilic binding agent provided according to the invention, the low water absorption ability of such a polymer particle foam may be preserved or even lowered further.

Additionally, it is also possible to use foamable and/or prefoamed polymer particles of a biopolymer. The biopolymer is preferably polylactide or polylactic acid and/or a biopolymer based on starch or cellulose, such as cellulose acetate, cellulose propionate or cellulose butyrate. As was already described above, biopolymers, in contrast to the above-mentioned polymers, are made of polar monomers.

Polymer particle foams produced therefrom therefore exhibit increased water wettability and water absorption ability. The water absorption ability can be reduced by coating the polymer particles with a non-hydrophilic binding agent.

The dual function of the non-hydrophilic binding agent, serving as an adhesive and as an impregnating agent, is particularly significant with the use of biopolymers. This is because biopolymers generally sinter more poorly than the above-described other polymers. As a result, additional adhesive bonding of the particles is indispensable if a stable bond among the particles is to be achieved.

Preferably, polymer particles that, in the prefoamed state, have a particle size of 2 to 10 mm, preferably of 2 to 8 mm, and more preferably of 3 to 7 mm, are used. In this way, the insulation elements achieve sufficiently good thermal insulating values.

It is furthermore preferred when 30 to 99 wt. %, preferably 40 to 98 wt. %, and more preferably 60 to 97 wt. % foamable and/or prefoamed polymer particles, and 1 to 70 wt. %, preferably 2 to 60 wt. %, and more preferably 3 to 40 wt. % binding agent are used, each based on the solids total weight of the starting materials. The amount of the binding agent content helps to ensure that the sound and/or thermal insulation element produced by the method according to the invention has high mechanical stability.

Moreover, customary additives can be added to the starting materials for producing a sound and/or thermal insulation element. The content of the additives is preferably 0 to 40 wt. %, preferably 0 to 30 wt. %, and more preferably 0 to 20 wt. %, based on the solids total weight of the starting materials.

Preferably, at least one additive, in particular in the form of a flame retardant, is added so as to lower the flammability or combustibility of the polymer particle foam. Preferably, the flame retardant used is an intumescent flame retardant, and preferably expandable graphite. Expandable graphite is generally present in the form of coarse particles and/or particles having edges, which ensure good integration with the polystyrene particles. Adding expandable graphite as a flame retardant therefore does not adversely affect the stability of the bond of the polymer particles among one another. Furthermore, the expandable graphite, in contrast to most conventional flame retardants, is toxicologically unobjectionable.

The flame retardant can be added in such a way that the polymer particles are additionally coated with the flame retardant before they are subjected to the shaping process. The coating with the flame retardant can take place prior to, during or after the coating with the binding agent. For example, the flame retardant can be added to the binding agent, so that the polymer particles can be coated with the flame retardant and the binding agent in a single coating operation.

For shaping, the coated polymer particles are preferably introduced into a mold and bonded and/or sintered while adding pressure and/or heat. The size of the interstitial spaces remaining between the polymer particles can be controlled by way of the pressure and/or temperature conditions during sintering. Depending on the respective degree of compression and/or the expansion of the polymer particles, a sound and/or thermal insulation element which additionally has a drainage function can thus be produced. Furthermore, an expansion-limiting effect is achieved via the binding agent, which surrounds the polymer particles during sintering as a binding agent film, and thereby counteracts an expansion of the particles. The extent of the expansion can thus be controlled by way of the binding agent content.

So as to achieve the object described above, furthermore a sound and/or thermal insulation element made of a polymer particle foam is provided, which comprises polymer particles that are bonded and/or sintered to one another, wherein the bonding, if provided, is caused by way of a binding agent with which the polymer particles have been coated, preferably prior to sintering. According to the invention, the binding agent is non-hydrophilic and forms a coating that envelopes the polymer particles at least partially. Preferably, a coating that envelopes the polymer particles substantially completely is achieved.

Since the binding agent coating substantially envelopes the individual polymer particles, the “inner” surfaces, which is to say the surfaces delimiting the interstitial spaces between the particles, are also coated with the binding agent. Subsequent impregnation so as to lower the hydrophilicity can therefore be dispensed with. The non-hydrophilic binding agent therefore has a dual function, namely that of an adhesive and that of an impregnating agent.

The coating with the non-hydrophilic binding agent causes the water wettability, and therefore the water absorption ability, of the sound and/or thermal insulation element to be accordingly low. In this way, it is ensured that penetrating moisture, in particular in the form of water and/or water vapor, does not worsen the insulation properties, and in particular the thermal insulation properties, of the sound and/or thermal insulation element. Penetrating moisture is reliably removed and not stored temporarily to a significant degree.

The indicated sound and/or thermal insulation element is therefore suitable, in particular, for use in outdoor areas and/or in areas prone to moisture. Furthermore, the sound and/or thermal insulation element can be used as a drainage element or board.

Non-hydrophilic within the meaning of the present application, shall be understood to mean, in particular, that at least one of the following parameters is met, which relate to the contact angle of water and/or to the surface energy.

Preferably, the binding agent forming the coating has an initial static contact angle of water after 1-minute equilibration≥35°, preferably ≥40°, and more preferably ≥50°.

Furthermore, a binding agent may be considered to be non-hydrophilic within the meaning of the present application if it has an overall surface energy≤70 mN/m, preferably ≤65° mN/m, and more preferably ≤60 mN/m.

Moreover, the binding agent forming the coating preferably has a polar part of the surface energy of ≤35 mN/m, preferably ≤30 mN/m, and more preferably ≤25 mN/m.

Furthermore, the binding agent forming the coating preferably has a dispersive part of the surface energy of ≥10 mN/m, preferably ≥20 mN/m, and more preferably ≥30 mN/m.

The coating is preferably formed by a binding agent based on acrylate, (meth)acrylate, styrene acrylate, vinyl acetate, vinyl acetate ethylene, vinyl esters, vinyl chloride, polyurethane, polysiloxane and/or silicone resins If the aforementioned parameters are not known, it may have to be ascertained beforehand by way of experimentation, where necessary, as to whether this is in fact a non-hydrophilic binding agent. For this purpose, a procedure as was already described above in conjunction with the method according to the invention may be employed.

The polymer particle foam preferably comprises polymer particles made of polystyrene, polyurethane, polypropylene, polyethylene and/or polyethylene terephthalate. These polymers comprise monomers that are nonpolar and therefore are already water repellent. This property can be achieved, or even enhanced, by way of the coating with the non-hydrophilic binding agent. Furthermore, active water absorption due to capillary action can be counteracted, for example so as to improve the drainage effect of the sound and/or thermal insulation board.

As an alternative, the polymer particle foam can comprise polymer particles made of a biopolymer, in particular made of polylactide and/or a biopolymer based on starch or cellulose, such as cellulose acetate, cellulose propionate and/or cellulose butyrate. Monomers of these biopolymers are polar by nature, and polymers are then relatively polar themselves. A sound and/or thermal insulation element produced therefrom thus has comparatively good water wettability and a high water absorption ability. However, the polymer particles enveloped by the coating containing the non-hydrophilic binding agent causes the water absorption ability to be lowered. In this respect, the advantages of the invention are particularly significant here.

It is furthermore provided that a flame retardant, preferably an intumescent flame retardant, and in particular expandable graphite, is present. The flame retardant lowers the flammability or combustibility of the sound and/or thermal insulation element. The advantages of expandable graphite were already mentioned above, so that reference is made thereto.

Furthermore, it is preferred that the sound and/or thermal insulation element according to the invention has been produced by the method according to the invention.

The method according to the invention and the sound and/or thermal insulation element according to the invention will be described hereafter in greater detail based on specific examples.

The following binding agents were used:

Binding agent 1: an aqueous copolymer dispersion made of vinyl acetate, ethylene and methacrylic acid esters, stabilized with polyvinyl alcohol, solids content approximately 50 wt. %.

Binding agent 2: an aqueous polymer dispersion made of acrylic and methacrylic acid esters, solids content approximately 48 wt. %.

Binding agent 3: a dispersion powder based on vinyl acetate and ethylene, stabilized with polyvinyl alcohol.

So as to ascertain the respective contact angles, in the present case of water and diiodomethane, and the surface energies, aqueous polymer dispersions and the dispersion powders that were previously redispersed using the same amount of water were applied, respectively, in a wet layer thickness of 250 μm to Lenetta film using a doctor blade and dried for three days at 23° C. and 50% relative humidity. Thereafter, the contact angles of the water or diiodomethane drops after a 1-minute equilibration time on the respective surface were measured, and the surface energies as well as the polar and dispersive parts of the respective surface energy were ascertained. The contact angles were measured by way of Krüss Mobile Drop GH11 (Advance Software Version 1.3.1), and more specifically on the three phase contact line between solid, liquid and gas. Five measurements each were carried out in different locations of the respective surfaces. For this purpose, five drops of water and diiodomethane were placed on the surfaces, respectively. The measuring results were then averaged.

The measuring results are compiled in the table below:

| | CW | CW | Overall | Polar | Dispersive |
|---|---|---|---|---|---|
| | water | Diiodomethane | SE | part | part |
| | [°] | [°] | [mN/M] | [mN/m] | [mN/m] |
| BA 1 | 27.1 | 121.6 | 75.1 | 72.7 | 2.9 |
| BA 2 | 73.4 | 53.3 | 40.4 | 8.0 | 32.4 |
| BA 3 | 41.4 | 33.7 | 64.3 | 21.7 | 42.6 |

In keeping with the definition of a non-hydrophilic binding agent provided in the present application, only binding agents 2 and 3 shall be regarded as such. Binding agent 1 is not covered by this definition.

### EXAMPLE 1

700 g prefoamed polystyrene particles having a particle size of 4 to 7 mm and a bulk density of approximately 15 kg/m³ was coated with 200 g of binding agent 1 by intimately mixing the polystyrene particles and the polymer dispersion. 150 g expandable graphite was added to the mixture prior to drying the polymer dispersion. 9 L of this mixture was added to a mold having a base surface area measuring 30 cm×30 cm and pressed under application of pressure and heat (100° C.), with water vapor serving as the heating medium flowing through the entire mold, to yield a board having the dimensions 30 cm×30 cm×7 cm. After the pressure was relieved, the shaped part was removed from the mold and dried over a period of one week at room temperature.

The shaped part thus produced had a thermal conductivity λ according to DIN EN 12667 of <35 W/(mK) and a density p according to DIN EN 1602 of 37.3 kg/m³. The water absorption according to DIN EN 1609 was 496 g/m².

### EXAMPLE 2

700 g prefoamed polystyrene particles having a particle size of 4 to 7 mm and a bulk density of approximately 15 kg/m³ was coated with 200 g of binding agent 2 by intimately mixing the polystyrene particles and the polymer dispersion. 150 g expandable graphite was added to the mixture prior to drying the polymer dispersion. 9 L of this mixture was added to a mold having a base surface area measuring 30 cm×30 cm and pressed under application of pressure and heat (100° C.), with water vapor serving as the heating medium flowing through the entire mold, to yield a board having the dimensions 30 cm×30 cm×7 cm. After the pressure was relieved, the shaped part was removed from the mold and dried over a period of one week at room temperature.

The shaped part thus produced had a thermal conductivity λ according to DIN EN 12667 of <35 W/(mK) and a density ρ according to DIN EN 1602 of 35.9 kg/m³. The water absorption according to DIN EN 1609 was 170 g/m².

### EXAMPLE 3

350 g foamable polystyrene particles (“EPS beads)” was mixed with 70 g of binding agent 3 and 100 g expandable graphite and prefoamed while adding pressure (1 bar) and heat (100° C.), wherein water vapor served as the heating medium. The dispersion powder softened and formed a polymer film on the prefoamed polystyrene particles, which secured the expandable graphite on the surface of the particles. Thereafter, the coated and prefoamed polymer particles were dried in a fluidized bed dryer. 9 L of the coated prefoamed polystyrene particles loaded with expandable graphite were placed in a mold measuring 30 cm×30 cm×10 cm and foaming was completed while applying pressure and heat, wherein again water vapor served as the heating medium. After the pressure was relieved, the shaped part was removed from the mold and dried over a period of one week at room temperature.

The shaped part thus produced had a thermal conductivity λ according to DIN EN 12667 of <33 W/(mK) and a density ρ according to DIN EN 1602 of 25.0 kg/m³. The water absorption according to DIN EN 1609 was 132 g/m².

### EXAMPLE 4

9 L of uncoated prefoamed polylactide particles having a particulate size of 2 to 3 mm and a bulk density of approximately 22 kg/m³ was added to a mold having a base surface area measuring 30 cm×30 cm and pressed under application of pressure and heat (100° C.), water vapor serving as the heating medium flowing through the entire mold, to yield a board having the dimensions 30 cm×30 cm×7 cm. After the pressure was relieved, the shaped part was removed from the mold and dried over a period of one week at room temperature.

The shaped part thus produced had a thermal conductivity λ according to DIN EN 12667 of <37 W/(mK) and a density ρ according to DIN EN 1602 of 27.9 kg/m³. The water absorption according to DIN EN 1609 was 1089 g/m².

### EXAMPLE 5

1000 g prefoamed polylactide particles having a particle size of 2 to 3 mm and a bulk density of approximately 22 kg/m³ was coated with 400 g of binding agent 2 by intimately mixing the polylactide particles and the polymer dispersion. 9 L of this mixture was added to a mold having a base surface area measuring 30 cm×30 cm and pressed under application of pressure and heat (100° C.), with water vapor serving as the heating medium flowing through the entire mold, to yield a board having the dimensions 30 cm×30 cm×7 cm. After the pressure was relieved, the shaped part was removed from the mold and dried over a period of one week at room temperature.

The shaped part thus produced had a thermal conductivity λ according to DIN EN 12667 of <38 W/(mK) and a density ρ according to DIN EN 1602 of 37.1 kg/m³. The water absorption according to DIN EN 1609 was 277 g/m².

The examples demonstrate that the use of a non-hydrophilic binding agent (binding agents 2 and 3 in the present case) according to Examples 2, 3 and 5 results in a shaped body in which the water absorption is considerably lower.

The shaped body according to Example 3 was furthermore tested with respect to the water permeability thereof. Water applied to the surface of the shaped part penetrated the same quickly and completely.

1-21. (canceled)

22. A method for producing a sound and/or thermal insulation element, comprising:
providing foamable and/or prefoamed polymer particles which are coated with a non-hydrophilic binding agent; and thereafter
subjecting the foamable and/or prefoamed polymer particles to a shaping process during which the foamable and/or prefoamed polymer particles are bonded and/or sintered to one another.

23. The method of claim 22, wherein the non-hydrophilic binding agent is an organic binding agent.

24. The method of claim 22, wherein the non-hydrophilic binding agent has an initial static contact angle of water after 1 minute of equilibration of ≥35°.

25. The method of claim 22, wherein the non-hydrophilic binding agent has a surface energy of ≤70 mN/m.

26. The method of claim 22, wherein the non-hydrophilic binding agent has a polar part of a surface energy of ≤35 mN/m.

27. The method of claim 22, wherein the non-hydrophilic binding agent has a dispersive part of a surface energy of ≥10 mN/m.

28. The method of claim 22, wherein the non-hydrophilic binding agent is an aqueous polymer dispersion or a dispersion powder based on at least one member of the group consisting of acrylate, (meth)acrylate, styrene acrylate, vinyl acetate, vinyl acetate ethylene, vinyl esters, vinyl chloride, polyurethane, polysiloxane, and silicone resins.

29. The method of claim 22, wherein the foamable and/or prefoamed polymer particles are made of at least one member of the group consisting of polystyrene, polyurethane, polypropylene, polyethylene, and polyethylene terephthalate.

30. The method of claim 22, wherein the foamable and/or prefoamed polymer particles are made of a biopolymer selected from the group consisting of a polylactide and/or a biopolymer based on a material selected from the group consisting of starch, cellulose, cellulose acetate, cellulose propionate, and cellulose butyrate.

31. The method of claim 22, wherein 30 to 99 wt. % of the foamable and/or prefoamed polymer particles are used and wherein 1 to 70 wt. % of the non-hydrophilic binding agent are used, wherein each is based on a solids total weight of starting materials.

32. The method of claim 22, further comprising providing the foamable and/or prefoamed polymer particles with flame retardant.

33. The method of claim 32, wherein the flame retardant is an intumescent flame retardant and/or expandable graphite.

34. The method of claim 22, further comprising introducing the foamable and/or prefoamed polymer particles into a mold for shaping, wherein the foamable and/or prefoamed polymer particles are bonded and/or sintered while adding pressure and/or heat.

35. A sound and/or thermal insulation element, comprising:
a polymer particle foam, comprising polymer particles that are bonded and/or sintered to one another, the bonding being caused by way of a non-hydrophilic binding agent that forms a coating that envelopes the polymer particles at least partially.

36. The sound and/or thermal insulation element of claim 35, wherein the non-hydrophilic binding agent is an organic binding agent.

37. The sound and/or thermal insulation element of claim 35, wherein the non-hydrophilic binding agent has an initial static contact angle of water after 1 minute of equilibration of ≥35°.

38. The sound and/or thermal insulation element of claim 35, wherein the non-hydrophilic binding agent has a total surface energy of ≤70 mN/m.

39. The sound and/or thermal insulation element of claim 35, wherein the non-hydrophilic binding agent has a polar part of a surface energy of ≤35 mN/m.

40. The sound and/or thermal insulation element of claim 35, wherein the non-hydrophilic binding agent has a dispersive part of the surface energy of ≥10 mN/m.

41. The sound and/or thermal insulation element of claim 35, wherein the non-hydrophilic binding agent is based on at least one member of the group consisting of acrylate, (meth)acrylate, styrene acrylate, vinyl acetate, vinyl acetate ethylene, vinyl esters, vinyl chloride, polyurethane, polysiloxane, and silicone resins.

42. The sound and/or thermal insulation element of claim 35, wherein the polymer particle foam comprises polymer particles made of at least one member of the group consisting of polystyrene, polyurethane, polypropylene, and polyethylene.

43. The sound and/or thermal insulation element of claim 35, wherein the polymer particle foam comprises polymer particles made of a biopolymer selected from the group consisting of a polylactide and/or a biopolymer based on a material selected from the group consisting of starch, cellulose, cellulose acetate, cellulose propionate, and cellulose butyrate.

44. The sound and/or thermal insulation element of claim 35, further comprising a flame retardant.

45. The sound and/or thermal insulation element of claim 35, wherein the flame retardant is selected from the group consisting of an intumescent flame retardant and expandable graphite.
